(19) United States
(12) Patent Application Publication
(10) Pub. No.: US 2024/0155478 A1
(43) Pub. Date: May 9, 2024

(54) METHOD AND APPARATUS FOR ESTABLISHING PDU SESSIONS USING A NETWORK SLICE

(71) Applicant: SAMSUNG ELECTRONICS CO., LTD., Suwon-si (KR)

(72) Inventors: Jagadeesh GANDIKOTA, Bangalore (IN); Danish Ehsan HASHIMI, Bangalore (IN); Jyotirmoy KARJEE, Bangalore, IN (US); Ankur POONIYA, Jhunjihunu (IN)

(73) Assignee: SAMSUNG ELECTRONICS CO., LTD., Suwon-si (KR)

(21) Appl. No.: 18/412,162

(22) Filed: Jan. 12, 2024

Related U.S. Application Data
(63) Continuation of application No. PCT/KR22/10259, filed on Jul. 14, 2022.

(30) Foreign Application Priority Data
Jul. 16, 2021 (IN) 20141032102

(51) Int. Cl. H04W 48/18; H04W 28/24; H04W 76/10

(52) U.S. Cl. CPC H04W 48/18; H04W 28/24; H04W 76/10

(57) ABSTRACT

An apparatus for selecting network slices for servicing application requests, includes: a memory storing at least one instruction; and at least one processor operatively connected to the memory and configured to execute the at least one instruction to: receive an application request from an application for establishing a new protocol data unit (PDU) session with a network over a first network slice, wherein the application request comprises one or more PDU session requirements, identify a plurality of network slices other than the first network slice, based on the one or more PDU session requirements; select a second network slice from the plurality of network slices, based on a configuration related to the apparatus; and perform a service corresponding to the application request using the second network slice.

### CROSS-REFERENCE TO RELATED APPLICATIONS

This application is a by-pass continuation application of International Application No. PCT/KR2022/010259, filed on Jul. 14, 2022, which is based on and claims priority to Indian Patent Application No. 202141032102, filed on Jul. 16, 2021, in the Indian Intellectual Property Office, the disclosures of which are incorporated by reference herein their entireties.

### BACKGROUND

### 1. Field

The disclosure relates to methods and systems for establishing network connections. More particularly, the disclosure relates to methods and systems for establishing protocol data unit (PDU) sessions using network slices in communication networks.

### 2. Description of the Related Art

Under fifth generation (5G) technology standards, network operators have implemented multiple network slices with varying characteristics. For example, slice A may offer low data rate, which may be suitable for background application syncing, and thus, the slice A may be offered as an unlimited data package. In contrast, slice B may offer high speed data rate, which may be suitable for streaming live videos, and thus, the slice B may be offered as a limited data package.

Based on user subscriptions and operator policies, User Equipment (UE) applications may be associated with different slices, such as the slice A and the slice B. The associations between the UE applications and the slices are defined at the network's end and are provided to the UE by the network. When service requests are raised by the applications, the UE establishes protocol data unit (PDU) sessions of the applications, based on the associations defined at the network's end.

In the related art of establishing PDU connections with the network, the network resources may not be utilized efficiently. For instance, in the related art, the UE may end up establishing multiple PDU sessions over multiple network slices. This may result in inefficient utilization of the network resources.

Thus, there is a need for a solution for at least one of the aforementioned deficiencies. There is a need for a solution to utilize the network resources efficiently when the UE establishes and utilizes the PDU sessions of the applications, based on the associations defined at the network's end.

### SUMMARY

Provided is, in establishing protocol data unit (PDU) sessions, an effective use of the network resources by identifying at least one network slice which satisfies one or more PDU session requirements defined in the application's request.

According to an aspect of the disclosure, an apparatus for selecting network slices for servicing application requests, includes: a memory storing at least one instruction; and at least one processor operatively connected to the memory and configured to execute the at least one instruction to: receive an application request from an application for establishing a new protocol data unit (PDU) session with a network over a first network slice, wherein the application request comprises one or more PDU session requirements, identify a plurality of network slices other than the first network slice, based on the one or more PDU session requirements; select a second network slice from the plurality of network slices, based on a configuration related to the apparatus; and perform a service corresponding to the application request using the second network slice.

According to an aspect of the disclosure, a method of servicing application requests from applications having low-latency Quality of Service (QoS) requirement in an electronic device, includes: receiving an application request from an application having the low-latency QoS requirement for establishing a dedicated protocol data unit (PDU) session with a network over a first network slice, wherein the application request comprises one or more PDU session requirements; identifying a second network slice having an Always-On PDU session previously established, based on the one or more PDU session requirements; determining whether a second network slice having the Always-On PDU session is available; based on a determination that the Always on PDU session of the second network slice is available, performing a handshake with the network using the Always-On PDU session of the second network slice; and establishing at least one of: the dedicated PDU session with the network over the first network slice; and, based on a determination that the Always-On PDU session is unavailable, a second Always-On PDU session with the network over the first network slice.

According to an aspect of the disclosure, a method for network slice selection performed by a user equipment (UE), includes: detecting that the UE is configured to set up a first data session for a first application using a first network slice from a plurality of network slices; receiving a request to initiate a second data session for a second application; detecting an availability of the plurality of network slices including the first network slice for the second application; and selecting the first network slice from the plurality of network slices and setting up the second data session for the second application.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a wireless communication system, according to one or more embodiments of the disclosure;

FIG. 2 illustrates a flowchart of selecting network slices for servicing application requests, according to an embodiment of the disclosure;

FIG. 3 illustrates a flowchart of selecting network slices for servicing application requests from applications having low-latency QoS requirements, according to an embodiment of the disclosure;

FIG. 4 illustrates a flowchart of selecting network slices for servicing application requests from applications having low-latency QoS requirements, according to an embodiment of the disclosure;

FIG. 5 illustrates a flowchart of selecting network slices for servicing application requests, according to an embodiment of the disclosure; and

FIG. 6 illustrates a block diagram of a User Equipment (UE), according to an embodiment of the disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

Reference is made to the embodiment illustrated in the drawings and specific language will be used to describe the same. No limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. The expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

In fifth generation (5G) technology standard, network operators have implemented multiple network slices with varying characteristics. For example, slice A may offer low data rate, which may be suitable for background application syncing, The slice A may offer unlimited data package. Slice B may offer high speed data rate, which may be suitable for streaming live videos. The slice B may offer limited data package. Based on user subscriptions and operator policies, multiple applications in a User Equipment (UE) may be associated with different slices. The associations between the multiple applications and the different slices may be defined at a ‘network’ and are provided to the UE by the network. Accordingly, when service requests are generated by the applications, the UE is configured to establish protocol data unit (PDU) sessions based on the network-defined associations.

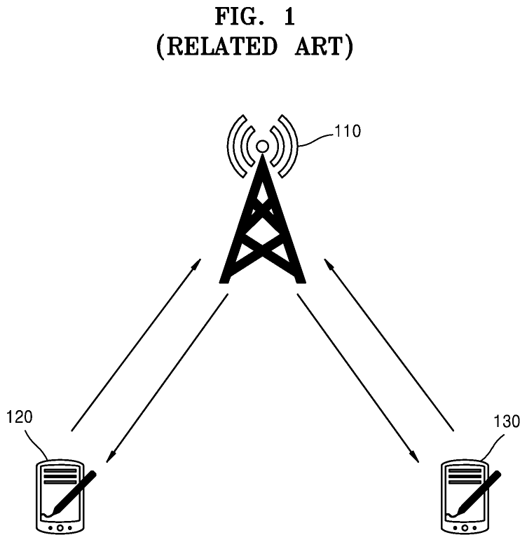

As used herein, a “network” or the “network” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node. In FIG. 1, a base station 110 is an example of the “network”.

In the related art of establishing PDU connections with the network, the network resources may not be utilized efficiently. For instance, consider a case where a first application of the UE has a first PDU session established over a first slice. Suppose that the user then launches a second application, which a traffic descriptor may request for establishing a second PDU session over a second slice. This operation results in activating multiple PDU sessions over multiple network slices. Now, in a case even if the first slice was sufficient to handle the application request, the second slice may be used, which may result in inefficient utilization of the network resources.

In an embodiment, because of the strict mapping of the applications to the network slices and formation of PDU sessions based on the strict mapping, the user experience of an application may suffer in a case that data limit associated with the network slice has exhausted. For multiple reasons, the policy may not be updated immediately, i.e., the data limit may not be reset, even after subscribing to additional data. For example, in a case of policy control function (PCF) not timely updating a new policy to the access and mobility function (AMF), the network may wait for the UE to release the existing PDU session.

In an embodiment, the UE, although having subscribed to or being associated with high speed slice, may still get lower data rate. This may occur in a case where, for example, the UE gets access to slice services at certain location where a user pool is very big for corresponding slice thereby causing congestion, and hence, lower data rate/services. In another case, the UE may get access to the slice services at particular time or event when the user pool is very big for corresponding slice thereby causing congestion, and hence, lower data rate/services. Thus, in both cases, the UE may experience a degraded user experience.

Thus, in the related art, there is a need of a solution for at least one of the aforementioned deficiencies.

FIG. 1 illustrates a wireless communication system according to an embodiment of the disclosure. More particularly, FIG. 1 illustrates a base station 110, a first terminal 120, and a second terminal 130 as wireless nodes that use wireless channels in a wireless communication system. Although a single base station 110 is illustrated in FIG. 1, another base station, which is the same as or different from the single base station 110, may be further included in the wireless communication system. Embodiments of the wireless communication system may include one or more terminals (e.g., the first terminal 120 and the second terminal 130), and at least one radio network node (e.g., the base station 110), capable of communicating with the first terminal 120 and the second terminal 130. The wireless communication system may also include any additional elements suitable to support communication between the first terminal 120 and the second terminal 130 or between a terminal (e.g., the first terminal 120), and another communication device (such as a landline telephone).

The base station 110 may be a network infrastructure that provides radio access to the first terminal 120 and the second terminal 130. The base station 110 may have a coverage defined by a predetermined geographic area based on a distance to which the base station 110 is capable of transmitting a signal. The base station 110 may be referred to as “access point (AP),” “eNodeB (eNB),” “gNodeB (gNB),” “5th generation node (5G node)”, “6th Generation Node (6G node)”, “wireless point,” “network node”, “transmission/reception point (TRP),” or other terms having equivalent technical meaning, in addition to “base station.” Furthermore, examples of the base station 110 may include but are not limited to gNb, VRAN, ORAN, C-RAN, etc. The base station 110 may be an example of the “network” defined in the above paragraph of the disclosure.

In an embodiment, each of the first terminal 120 and the second terminal 130 is a device used by a user, and may perform communication with the base station 110 via at least one wireless channel. In some cases, at least one of the first terminal 120 and the second terminal 130 may not be operated by a user. That is, at least one of the terminals 120 and the second terminal 130 may be a device that performs machine type communication (MTC), and may not be carried by a user. Each of the first terminal 120 and the second terminal 130 may be referred to as a “user equipment (UE),” “mobile station,” “subscriber station,” “remote terminal,” “wireless terminal,” “user device,” “mobile phone”, “mobile device” or other terms having the equivalent technical meaning, in addition to a “terminal.”

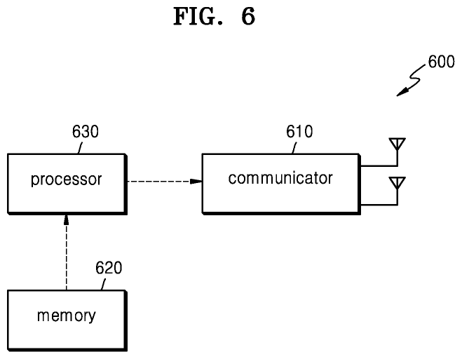

In an example, a UE may include any suitable combination of hardware and/or software. In some embodiments, the first terminal 120 or the scone terminal 130 may include components described below and shown in FIG. 6.

The base station 110, the first terminal 120, and the second terminal 130 may transmit and receive wireless signals in a millimeter wave (mmWave) band (e.g., 28 GHz, 30 GHz, 38 GHz, or 60 GHz). In this case, to improve a channel gain, the base station 110, the first terminal 120, and the second terminal 130 may perform beamforming. Here, the beamforming may include transmission beamforming and reception beamforming. That is, the base station 110, the first terminal 120, and the second terminal 130 may assign directivity to a transmission signal or a reception signal. To this end, the base station 110 and the first terminal 120 and the second terminal 130 may select serving beams via a beam search or beam management procedure. After the serving beams are selected, communication may be established via resources that are in the quasi co-located (QCL) relationship with resources used for transmitting the serving beams.

In an embodiment, the base station 110, the first terminal 120, and the second terminal 130 may transmit and receive wireless signals in a band other than the millimeter wave band. In other words, the band at which the base station 110, the first terminal 120, and the second terminal 130 transmit and receive wireless signals is not limited to the millimeter wave band. In this case, the base station 110, the first terminal 120, and the second terminal 130 may perform mutual communication without performing beamforming.

In an example, in the wireless communication system, the base station 110, the first terminal 120, and the second terminal 130 may use any suitable radio access technology, such as long term evolution (LTE), LTE-Advanced, universal mobile telecommunications service (UMTS), high speed packet access (HSPA), global system for mobile communications (GSM), cdma2000, new radio (NR), WiMax, WiFi, and/or other suitable radio access technology. In an example, the wireless communication system may include any suitable combination of one or more radio access technologies. For purposes of example, various embodiments may be described within the context of certain radio access technologies. However, the scope of the disclosure is not limited to the examples and other embodiments could use different radio access technologies.

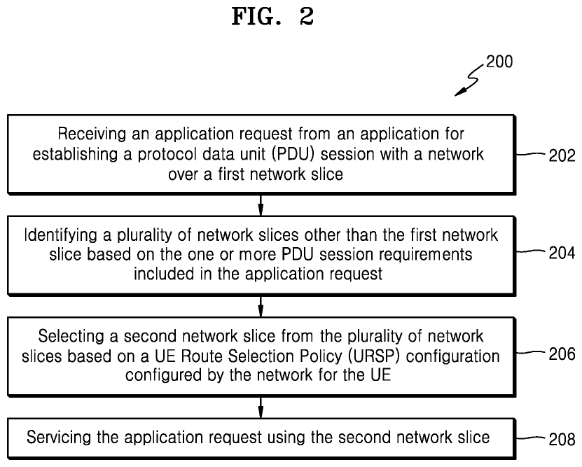

FIG. 2 illustrates a flowchart of selecting network slices for servicing application requests, according to an embodiment of the disclosure. In an example, the method 200 may be implemented by the UE 120, which corresponds to the first terminal 120 in FIG. 1, for selecting network slices for performing a service corresponding to application requests raised or generated by applications of the UE 120. The operations in FIG. 2 may be performed by at least one processor of the UE 120.

In operation 202, an application request from an application for establishing a new protocol data unit (PDU) session with the ‘network’ over a first network slice is received. In an embodiment, the application request may include one or more PDU session requirements, such as, for example, minimum bit rate (MBR), guaranteed bit rate (GBR), SSC Mode, IP type, connection capabilities, etc. The application request may be raised or generated by an application which may seek to initiate an operation of data transfer to the network, for example, a data network. Accordingly, the application request may include a data network name (DNN) of the data network. In an example, a processor of the UE 120 may receive the application request from an application of the UE 120.

In operation 204, a plurality of network slices other than the first network slice is identified, based on the one or more PDU session requirements defined in the application request. A plurality of currently active network slices may be identified. An active network slice may be a network slice over which at least one PDU session with a DNN is already established. In an example, from these identified active network slices, the plurality of network slices other than the first network slice may be identified. The plurality of network slices include active network slices that at least match or exceed the PDU session requirements defined in the application request. In an example, the processor of the UE 120 may implement or include a ‘network slice selector’ for identifying the plurality of network slices.

In an embodiment, the identification of the plurality of network slices need not be restricted from the active network slices and may be done from all the network slices available to the UE 120. In an embodiment, the plurality of network slices may be simply identified based on the PDU session requirements and all such network slices which at the least match or exceed the PDU session requirements may be identified.

In an example, for the identification of the plurality of network slices, the network slice selector (or the processor) may further evaluate a current subscription of slices of the UE 120 based on subscription information received from various sources such as application and core network. In a case that the subscription of network slice is valid, it may also be determined how many applications are currently associated with a given network slice being evaluated, and whether the network slice can fulfill the data requirement. This determination of the fulfillment of the data requirement may be made based on application usage history of the application which raised the application request. After all the aforementioned evaluations, in a case that the network slice fulfills the criteria, the plurality of network slices may be identified.

In operation 206, a second network slice from the plurality of network slices may be selected based on a UE Route Selection Policy (URSP) configuration defined by the network for the UE. In this operation, a determination may be made as to whether the plurality of network slices are permissible or allowable with respect to the URSP configuration. Accordingly, only those network slices, which are permissible or allowable, may be identified. Then, from among these identified network slices, the second network slice may be selected.

The selection of the second network slice from the plurality of network slices identified above may be done in one of various manners as described below.

In an embodiment, the selection of the second network slice may be done based on remaining data capacity of the plurality of network slices. The selection of the second network slice may be beneficial in preserving the data limits in the network slices. In an embodiment, each network slice in the plurality of network slices may have an ongoing PDU session. In an embodiment, a remaining data capacity of each network slice of the plurality of network slices may be determined. Based on the determined remaining data capacity of each of the plurality of network slices, a network slice having the highest remaining data capacity may be identified from the plurality of network slices. This identified network slice may subsequently be selected as the ‘second’ network slice.

In an embodiment, the UE 120 receives a data plan from an application processor via any messaging service and the like about a total data capacity. The total data capacity is, for example, 10 GB data. Then, the first application may make the Application Request and a second slice where a PDU session for a second application continues to consume certain amount of the data capacity, e.g., 3 GB. The UE 120 may first determine the remaining data capacity from the total data capacity based on the consumed amount of the data capacity. Thus, in this embodiment, 7 GB becomes the remaining data capacity. Likewise, the remaining data capacity of each network slice of the one or more network slices is determined. Then the network slice, which has the highest data capacity, will be selected as a second network slice for performing a corresponding service in response to the application request of the first application.

In an embodiment, the selection of the second network slice may be performed based on congestion associated with the plurality of network slices. This selection may be beneficial to avoid degraded quality-of-service (QoS) due to congestion. This selection would also help in avoiding further congestion. In an embodiment, a current location of the UE 120 may be detected, and a congestion database may be accessed. The congestion database may be include temporal congestion data associated with the plurality of network slices for a plurality of locations. The temporal congestion data may include a classification of each of the plurality of network slices for a plurality of time instances for a plurality of locations. Here, the classification is a classification regarding one of a congested network slice and a non-congested network slice.

Thus, based on the congestion database and the location of the UE 120, one or more non-congested network slices may be identified. Subsequently, a network slice from the one or more non-congested network slices may be selected as the second network slice, based on one or more user parameters. In an embodiment, the user parameters may include, but are not limited to, at least one of a user subscription and usage statistics of the application.

In an embodiment, where the location of the UE 120 is not detected in the congestion database, one or more network parameters for each of the plurality of network slices may be captured in real-time during a predetermined period. In an embodiment, the one or more network parameters may include at least one of a congestion window, a round trip time, a number of un-acknowledged packets, a number of retransmitted packets, and one or more lower layer parameters.

Accordingly, one or more non-congested network slices may be identified in the plurality of network slices based on the captured one or more network parameters. For the identification, the one or more network parameters may be provided as inputs to a trained model that has been trained using a machine learning (ML) technique, such as a reinforcement learning technique.

In an embodiment, the trained model may be configured to determine a performance gain corresponding to each (or at least one) of the plurality of network slices based on the captured one or more network parameters. Subsequently, the trained model may determine a network slice as a congested network slice based on the performance gain that is determined to be lower than a first threshold. In an embodiment, the trained model may determine a network slice as a non-congested network slice based on that performance gain that is determined to be higher than the first threshold. Accordingly, the trained model may identify the one or more non-congested network slices in the plurality of network slices based on the captured one or more network parameters.

In an embodiment, to determine the performance gain, the first threshold value is preset based on a throughput of the network. In particular, the first threshold value may be defined as the user slice threshold which is fixed for each parameter. For example, a set threshold value (throughput) is set to 0.3. The set threshold value (throughput) corresponds to the first threshold value. Thus, an expected reward point has been assigned to the each network slice. Thus, based on the rewards points defined by the first threshold value, the network slice is determined as congested network slice or non-congested network slice as explained above.

Subsequently, a network slice from the one or more non-congested network slices may be selected as the second network slice for performing a corresponding service in response to (or based on) the application request, based on the one or more user parameters. In an embodiment, a network slice, which is within the user subscription package and has adequate data limit which can serve the data requirement of the application request as predicted from the usage history of the application, may be selected as the second network slice.

In an embodiment, the operation 204 may be triggered based on identifying that the first network slice has a predefined limit of data capacity. In such a case, the operation 204 and subsequent operations are triggered. Accordingly, in operation 206, a network slice from the plurality of network slices having the highest corresponding remaining capacity may be identified. Subsequently, the identified network slice may be selected as the second network slice for performing a corresponding service in response to the application request. Thus, by using this second network slice, the data limit of the first network slice may be preserved.

In an embodiment, the predefined limit of data capacity may be either selected by a user or selected for each (or at least one) of the slices by an algorithm. Thus, in a scenario of the total data capacity being 10 GB, the user may preset the predefined limit of data capacity as 5 GB. Then, in a case when the data usage has reached the predefined limit of data capacity then the operation 204 and subsequent operations are triggered as disclosed above.

In an embodiment, the operation 204 may be triggered based on identifying that a capacity of first network slice has been exhausted. As an example, the each network slice has been assigned with a defined data capacity. Thus, when the assigned data capacity exhausted, the network may reduce the data speed after the expiration and/or the exhaustion of the assigned data capacity. In such a case, the operation 204 and subsequent operations are triggered. Accordingly, in operation 206, a network slice from the plurality of network slices having the highest corresponding remaining capacity may be identified. Subsequently, the identified network slice may be selected as the second network slice for performing a corresponding service in response to the application request. Thus, by using this second network slice, the data limit of the first network slice may be preserved.

In an embodiment, the second network slice may be selected based on a QoS associated with the application request. As an example, the QoS may be defined in at the network side and provided while establishing PDU session. In the embodiment, the QoS associated with the application request may be identified based on the one or more PDU session requirements included in the application request. Subsequently, a network slice, which is capable of performing a corresponding service for the application regarding the QoS, may be identified, and accordingly, selected as the second network slice.

In operation 208, the application request is served or supported through the second network slice. In an embodiment, once the second network slice is selected, the first network slice may be throttled. To that end, an internal rejection message may be transmitted to an application layer of the UE 120 and a traffic descriptor included in the application request may be modified. The modification is performed such that the modified traffic descriptor does not match a traffic descriptor of the first network slice. The modified traffic descriptor in an example may match with the traffic descriptor of the second network slice.

For performing a corresponding service in response to (or based on) the application request through the network slice, in an example, an existing PDU session, which is already established over the second network slice, may be used for performing a corresponding service in response to the application request using the second network slice. In an embodiment, the new PDU session may be established over the second network slice for performing a corresponding service in response to (or based on) the application request using the second network slice. In either case, the application may subsequently exchange data with the network.

In an embodiment, the second network slice may be a default network slice. For instance, in the case of congestion or in other cases as well, if no suitable alternate network slice is found, the second network slice may be the default network slice, if it is capable of performing a corresponding service in response to the application request. In an embodiment, if none of the plurality of network slices are allowable as per the URSP rule, then the second network slice may be the default network slice.

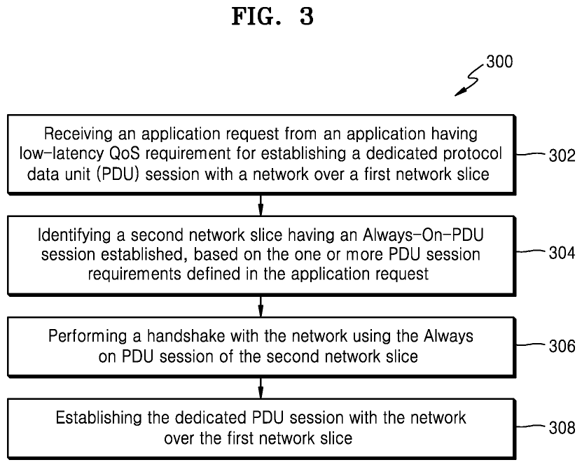

FIG. 3 illustrates a flowchart of selecting network slices for performing a corresponding service in response to application requests from applications having low-latency QoS requirements, according to an embodiment of the disclosure. In an example, the method 300 of selecting network slices may be implemented by the UE 120 for selecting network slices for performing a corresponding service in response to application requests raised or generated by applications of the UE 120.

In operation 302, an application request from an application having low-latency QoS requirement may be received for establishing a dedicated protocol data unit (PDU) session with a network over a first network slice. The application request, in an example, may include one or more PDU session requirements.

In operation 304, a second network slice having an established Always-On-PDU session may be identified based on the one or more PDU session requirements defined in the application request. Herein, the second network slice has an Always-On-PDU session which is in compliance with the PDU session requirements of the application request.

In operation 306, a handshake with the network is performed using the Always-On PDU session of the second network slice. The Always-On PDU session is a PDU session which is a session being always ‘on’. By performing the handshake using the Always-On PDU session, the UE 120 may save time. For instance, without the Always-On PDU session, the UE 120 would first have to perform a handshake with the network. Only after the handshake is completed, the UE 120 can then establish the PDU session. However, with the Always-On PDU session that can be leveraged, the handshake can be performed in parallel to the PDU session establishment. Thus, the UE 120 can save time required to connect to the network.

In operation 308, the dedicated PDU session with the network is established over the first network slice. As explained above, the handshake is performed using the already established Always-On PDU session. Accordingly, the PDU session establishment may be performed in parallel to the handshake being performed over the second network slice.

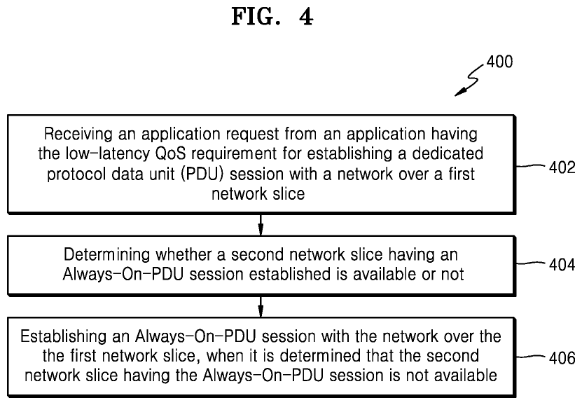

FIG. 4 illustrates a flowchart of selecting network slices for servicing application requests from applications having low-latency QoS requirements, according to an embodiment of the disclosure. In an example, the method 400 of selecting network slices for servicing application requests may be implemented by the UE 120 for selecting network slices for performing a corresponding service in response to application requests raised by applications of the UE 120.

In operation 402, an application request from an application having low-latency QoS requirement may be received for establishing a dedicated protocol data unit (PDU) session with a network over a first network slice. The application request, in an example, may include one or more PDU session requirements.

In operation 404, it is ascertained whether a second network slice having an Always-On PDU session established is available or not. In case the second network slice having the Always-On PDU session established is not available, in operation 406, the Always-On PDU session is established with the network over the first network slice. As explained above referring to FIG. 3, this Always-On PDU session may then be used in the further application requests for performing the handshake in parallel to the establishment of further PDU sessions. Thus, time associated with further PDU session establishment may be reduced.

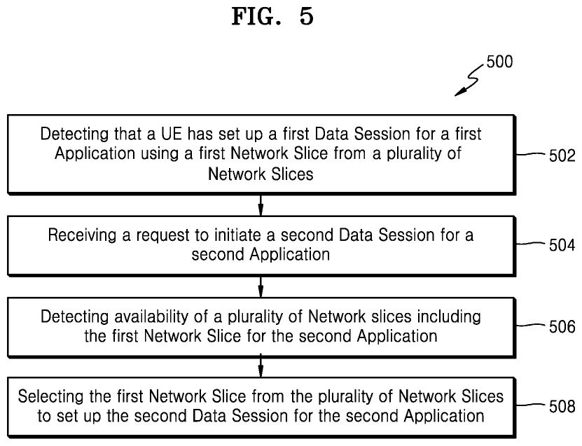

FIG. 5 illustrates a flowchart of selecting network slices for performing a corresponding service in response to application requests, according to an embodiment of the disclosure. In an example, the method 500 of selecting network slices may be implemented by the UE 120 for selecting network slices for performing a corresponding service in response to application requests raised by applications of the UE 120.

In operation 502, it is detected that a UE has set up a first data session for a first application using a first network slice from a plurality of network slices.

In operation 504, a request to initiate a second data session for a second application is received.

In operation 506, an availability of a plurality of network slices including the first network slice for the second application is detected. In a case that the availability of the plurality of network slices is detected, the first network slice from the plurality of network slices is selected to set up the second data session for the second application.

Furthermore, in the method 500, selecting the first network slice from the plurality of network slices to set up the second data session for the second application may include the following operations. At first, when the first network slice is used by the first data session, remaining capacity of the first network slice may be determined. Furthermore, it may be checked if the requirement of the second data session is less than the remaining capacity of the first network slice. Accordingly, the first network slice from the plurality of network slices may be selected to set up the second data session for the second application if the requirement of the second data session is determined to be less than the remaining capacity of the first network slice.

In an embodiment, the method 500 may further include selecting a second network slice from the plurality of network slices if the requirement of the second data session is more than the remaining capacity of the first network slice.

FIG. 6 is a block diagram illustrating the configuration of a UE 600, according to an embodiment of the disclosure. The configuration of FIG. 6 may be a part of the configuration of the UE 600. Hereinafter, terms including “unit” or “˜er” attached at the end of a component may refer to the unit for processing at least one function or operation and may be implemented as a hardware device. Furthermore, in an example embodiment, the UE 600 may be a wireless terminal, such as a smartphone. In an embodiment, the UE 600 may be a computing device implemented in vehicles for inter-vehicle communication. In the description below, the UE 600 may interchangeably be referred to as subject node.

In an embodiment, the UE 600 may transmit and receive wireless signals in a millimeter wave (mmWave) band (e.g., 28 GHz, 30 GHz, 38 GHz, or 60 GHz). In this case, to improve a channel gain, the UE 600 may perform beamforming. Here, the beamforming may include transmission beamforming and reception beamforming. That is, the UE 600 may assign directivity to a transmission signal or a reception signal. To this end, the UE 600 may select serving beams via a beam search or beam management procedure. After the serving beams are selected, communication may be performed via resources that are in the quasi co-located (QCL) relationship with resources used for transmitting the serving beams.

In an embodiment, the UE 600 may transmit and/or receive wireless signals in a band other than the millimeter wave band. In other words, the band at which the UE 600 transmits and receives wireless signals is not limited to the millimeter wave band. In this case, the UE 600 may perform mutual communication with another entity, without performing beamforming.

In an example, the UE 600 may use any suitable radio access technology, such as long term evolution (LTE), LTE-Advanced, UMTS, HSPA, GSM, cdma2000, NR, Wi-Max, Wi-Fi, and/or other suitable radio access technology.

In FIG. 6, the UE 600 may include a communicator 610 (e.g., communication interface), a memory 620 (e.g., storage or a storage unit), and a processor 630 (e.g., at least one processor). By way of examples, the first terminal 120 may be an electronic device, a cellular phone, or another device that communicates over a cellular network (such as a 5G or pre-5G network or any future wireless communication network). In some embodiments, the communicator 610 and the memory 620 may be combined into the processor 630.

The communicator 610 may perform functions for transmitting and/or receiving signals via a wireless channel. For example, the communicator 610 performs a function of conversion between a baseband signal and a bit stream according to the physical layer standard of a system. By way of further example, when data is transmitted, the communicator 610 generates complex symbols by encoding and modulating a transmission bit stream. Similarly, when data is received, the communicator 610 restores a reception bit stream by demodulating and decoding a baseband signal. Furthermore, the communicator 610 up-converts a baseband signal into an RF band signal and transmits the same via an antenna, and down-converts an RF band signal received via an antenna into a baseband signal. For example, the communicator 610 may include at least one of a transmission filter, a reception filter, an amplifier, a mixer, an oscillator, a Digital-to-Analog Converter (DAC), an Analog-to-Digital Converter (ADC), and the like.

Also, the communicator 610 may include or utilize a plurality of transmission and reception paths. In addition, the communicator 610 may include at least one antenna array including a plurality of antenna elements. From the perspective of hardware, the communicator 610 may include a digital circuit and an analog circuit (e.g., a radio frequency integrated circuit (RFIC)). Here, the digital circuit and the analog circuit may be implemented as one package. Also, the communicator 610 may include a plurality of RF chains. In addition, the communicator 610 may perform beamforming.

The communicator 610 may transmit and receive a signal as described above. Accordingly, the entirety or a part of the communicator 610 may be referred to as “transmitting unit,” “receiving unit,” “transceiving unit,” “transmitter,” “receiver,” or “transceiver.” Also, the transmission and reception performed via a wireless channel, which is described herein below, may include the above-described processing performed by the communicator 610.

The memory 620 may store data, such as a basic program, an application program, configuration information, and the like for operating the UE 600. The memory 620 may be configured as a volatile memory, a non-volatile memory, or a combination of a volatile memory and a non-volatile memory. In addition, the memory 620 may provide data stored therein in response to a request from the processor 630.

The processor 630 may control overall operations of the UE 600. For example, the processor 630 may transmit and receive signals via the wireless communicator 610. Further, the processor 630 records data in the memory 620 and reads the recorded data. The processor 630 may perform the functions of a protocol stack required by a particular communication standard. To this end, the processor 630 may be or include at least one processor. The at least one processor may perform the operations described referring to FIGS. 2-5. The processor may include the network slice selector.

In an embodiment, the processor 630 may be configured to receive an application request from an application for establishing a new PDU session with a network over a first network slice. The application request may define one or more PDU session requirements. Furthermore, the processor 630 may be configured to identify a plurality of network slices other than the first network slice based on the one or more PDU session requirements defined in the application request. Furthermore, the processor 630 may be configured to select a second network slice from the plurality of network slices based on a UE Route Selection Policy (URSP) configuration defined by the network for the UE 600. Furthermore, the processor 630 may be configured to serve or service the application request using the second network slice.

In an example embodiment, the processor 630 may be configured to establish a new PDU session over the second network slice for performing a corresponding service in response to the application request using the second network slice. In an embodiment, the controller 640 may be configured to use an existing PDU session that is already established over the second network slice for performing a corresponding service in response to the application request using the second network slice.

In an embodiment, each network slice in the plurality of network slices has an ongoing PDU session. In said example embodiment, the processor 630 may be configured to determine a remaining data capacity of each network slice of the plurality of network slices. Subsequently, the processor 630 may be configured to identify a network slice from the plurality of network slices having the highest corresponding remaining data capacity. Furthermore, the processor 630 may be configured to select the identified network slice as the second network slice for performing a corresponding service in response to the application request.

In an embodiment, the processor 630 may be configured to capture, in real-time for a predetermined period, one or more network parameters for each of the plurality of network slices. Furthermore, the processor 630 may be configured to identify one or more non-congested network slices in the plurality of network slices based on the captured one or more network parameters. In an embodiment, the processor 630 may be configured to determine a performance gain corresponding to each of the plurality of network slices based on the captured one or more network parameters. Furthermore, the processor 630 may be configured to determine a network slice as a congested network slice based on that the performance gain is determined to be lower than a first threshold. Furthermore, the processor 630 may be configured to determine a network slice as a non-congested network slice based on that the performance gain is determined to be higher than the first threshold. Furthermore, the processor 630 may be configured to select a network slice from the one or more non-congested network slices as the second network slice for performing a corresponding service in response to the application request, based on one or more user parameters.

In an embodiment, the processor 630 may be configured to detect a current location of the UE 120. Furthermore, the processor 630 may be configured to access a congestion database comprising temporal congestion data associated with the plurality of network slices for a plurality of locations. Furthermore, the processor 630 may be configured to identify one or more non-congested network slices based on the congestion database and the current location of the UE. Furthermore, the processor 630 may be configured to select a network slice from the one or more non-congested network slices as the second network slice for performing a corresponding service in response to the application request, based on one or more user parameters. In an embodiment, the user parameters may include, but are not limited to, at least one of a user subscription and a usage statistics of the application.

In an embodiment, the processor 630 may be configured to identify that the first network slice has a predefined limit of data capacity. Furthermore, the processor 630 may be configured to identify a network slice from the plurality of network slices having the highest corresponding remaining capacity. Accordingly, the processor 630 may be configured to select the identified network slice as the second network slice for performing a corresponding service in response to the application request.

In an embodiment, the processor 630 may be configured to determine that a capacity of the first network slice has been exhausted. Furthermore, the processor 630 may be configured to identify a network slice from the plurality of network slices having the highest corresponding remaining capacity. Furthermore, the processor 630 may be configured to select the identified network slice as the second network slice for performing a corresponding service in response to the application request.

In an embodiment, the processor 630 may be configured to identify a Quality of Service (QoS) associated with the application request, based on the one or more PDU session requirements defined in the application request. Furthermore, the processor 630 may be configured to identify a network slice from the plurality of network slices for performing a corresponding service in response to the application request, based on the QoS associated with the application request. Furthermore, the processor 630 may be configured to select the identified network slice as the second network slice for performing a corresponding service in response to the application request.

In an embodiment, the processor 630 may be configured to throttle the first network slice. To that end, the processor 630 may be configured to send an internal rejection message to an application layer of the UE 600. Furthermore, the processor 630 may be configured to modify a traffic descriptor included in the application request so as to not match with a traffic descriptor of the first network slice.

In an embodiment, the processor 630 may be configured to serve or service application requests from applications having low-latency Quality of Service (QoS) requirement. To that end, the processor 630 may be configured to receive an application request from an application having the low-latency QoS requirement for establishing a dedicated PDU session with a network over a first network slice. The application request may define one or more PDU session requirements. Furthermore, the processor 630 may be configured to identify a second network slice having an established Always-On PDU session, based on the one or more PDU session requirements defined in the application request. Furthermore, the processor 630 may be configured to perform a handshake with the network using the Always-On PDU session of the second network slice. Furthermore, the processor 630 may be configured to establish the dedicated PDU session with the network over the first network slice.

In an embodiment, the processor 630 may be configured to service application requests from applications having low-latency Quality of Service (QoS) requirement. To that end, the processor 630 may be configured to receive an application request from an application having the low-latency QoS requirement for establishing a dedicated PDU session with a network over a first network slice. The application request may define one or more PDU session requirements. Furthermore, the processor 630 may be configured to determine whether a second network slice having an Always-On PDU session established is available or not. Furthermore, the processor 630 may be configured to establish an Always-On PDU session with the network over the first network slice, when it is determined that the second network slice having the Always-On PDU session is not available.

In an embodiment, the processor 630 may be configured to detect that a UE has set up a first data session for a first application using a first network slice from a plurality of network slices. Furthermore, the processor 630 may be configured to receive a request to initiate a second data session for a second application. Furthermore, the processor 630 may be configured to detect availability of a plurality of network slices including the first network slice for the second application. Furthermore, the processor 630 may be configured to select the first network slice from the plurality of network slices to set up the second data session for the second application.

In an embodiment, the processor 630 may be configured to determine remaining capacity of the first network slice when being used by the first data session. Furthermore, the processor 630 may be configured to check if the requirement of the second data session is less than the remaining capacity of the first network slice. Furthermore, the processor 630 may be configured to select the first network slice from the plurality of network slices to set up the second data session for the second application if the requirement of the second data session is less than the remaining capacity of the first network slice.

In an example embodiment, the processor 630 may be configured to select a second network slice from the plurality of network slices if the requirement of the second data session is more than the remaining capacity of the first network slice.

The embodiments may be described and illustrated in terms of blocks, as shown in the drawings, which carry out a described function or functions. These blocks, which may be referred to herein as the network slice selector and the communicator 610 or the like may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While specific language has been used to describe the disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. An apparatus for selecting network slices for servicing application requests, the apparatus comprising:
a memory storing at least one instruction; and
at least one processor operatively connected to the memory and configured to execute the at least one instruction to:
receive an application request from an application for establishing a new protocol data unit (PDU) session with a network over a first network slice, wherein the application request comprises one or more PDU session requirements,
identify a plurality of network slices other than the first network slice, based on the one or more PDU session requirements;
select a second network slice from the plurality of network slices, based on a configuration related to the apparatus; and
perform a service corresponding to the application request using the second network slice.

2. The apparatus of claim 1, wherein the performing the service corresponding to the application request using the second network slice comprises establishing the new PDU session over the second network slice.

3. The apparatus of claim 1, wherein the performing the service corresponding to the application request using the second network slice comprises using an existing PDU session that is already established over the second network slice.

4. The apparatus of claim 2, wherein each network slice in the plurality of network slices has an ongoing PDU session, and
wherein the at least one processor is further configured to:
determine a remaining data capacity of each network slice of the plurality of network slices;
identify, from the plurality of network slices, a network slice having the highest remaining data capacity; and
select the identified network slice as the second network slice for servicing the application request.

5. The apparatus of claim 4, wherein the at least one processor is further configured to:
capture, during a predetermined period, one or more network parameters for at least one of the plurality of network slices,
identify one or more non-congested network slices in the plurality of network slices based on the captured one or more network parameters, and
select a network slice from the one or more non-congested network slices as the second network slice, based on one or more user parameters.

6. The apparatus of claim 5, wherein the identifying the one or more non-congested network slice further comprises:
determining a performance gain corresponding to the at least one of the plurality of network slices, based on the captured one or more network parameters;
based on the performance gain being determined to be lower than a first threshold, determining a network slice as a congested network slice; and
based on the performance gain being determined to be higher than the first threshold, determining a network slice as a non-congested network slice.

7. The apparatus of claim 6, wherein the at least one processor is further configured to:
detect a current location of the apparatus;
access a congestion database comprising temporal congestion data associated with the plurality of network slices for a plurality of locations;
identify the one or more non-congested network slices based on the congestion database and the current location of the apparatus; and
select a network slice from the one or more non-congested network slices as the second network slice, based on the one or more user parameters.

8. The apparatus of claim 7, wherein the at least one processor is further configured to:
identify that the first network slice has a predefined limit of data capacity;
based on identifying that the first network slice has the predefined limit of data capacity, identify, from the plurality of network slices, a network slice having the highest remaining data capacity; and
select the identified network slice as the second network slice.

9. The apparatus of claim 8, wherein the at least one processor is further configured to:
determine that a capacity of the first network slice is exhausted;
identify, from the plurality of network slices, a network slice having the highest remaining capacity; and
select the identified network slice as the second network slice.

10. The apparatus of claim 9, wherein the at least one processor is further configured to:
identify a Quality of Service (QoS) associated with the application request based on the one or more PDU session requirements defined in the application request;
identify, from the plurality of network slices, a network slice, based on the QoS associated with the application request; and
select the identified network slice as the second network slice.

11. The apparatus of claim 10, wherein the at least one processor is further configured to:
throttle the first network slice on identifying a network slice from the plurality of network slices for servicing the application request based on the QoS associated with the application request; and
select the identified network slice as the second network slice,
wherein the throttling first network slice comprises at least one of:
sending an internal packet data network (PDN) connection rejection message to an application layer of the apparatus; and
modifying a traffic descriptor included in the application request so as not to match with a traffic descriptor of the first network slice.

12. The apparatus of claim 11, wherein the second network slice is a default network slice.

13. The apparatus of claim 1, wherein the configuration related to the apparatus is a user equipment route selection policy (URSP) configuration configured by the network for the apparatus.

14. A method of servicing application requests from applications having low-latency Quality of Service (QoS) requirement in an electronic device, the method comprising:
receiving an application request from an application having the low-latency QoS requirement for establishing a dedicated protocol data unit (PDU) session with a network over a first network slice, wherein the application request comprises one or more PDU session requirements;
identifying a second network slice having an Always-On PDU session previously established, based on the one or more PDU session requirements;
determining whether a second network slice having the Always-On PDU session is available;
based on a determination that the Always on PDU session of the second network slice is available, performing a handshake with the network using the Always-On PDU session of the second network slice; and
establishing at least one of:
the dedicated PDU session with the network over the first network slice; and
based on a determination that the Always-On PDU session is unavailable, a second Always-On PDU session with the network over the first network slice.

15. A method for network slice selection performed by a user equipment (UE), the method comprising:
detecting that the UE is configured to set up a first data session for a first application using a first network slice from a plurality of network slices;
receiving a request to initiate a second data session for a second application;
detecting an availability of the plurality of network slices including the first network slice for the second application; and
selecting the first network slice from the plurality of network slices and setting up the second data session for the second application.

16. The method of claim 15, wherein the selecting the first network slice from the plurality of network slices and the setting up the second data session for the second application comprises:
based on identifying that the first network slice is used by the first data session, determining a remaining capacity of the first network slice;
checking whether a requirement of the second data session is less than the remaining capacity of the first network slice; and
based on identifying that the requirement of the second data session is less than the remaining capacity of the first network slice, selecting the first network slice from the plurality of network slices and setting up the second data session for the second application.

17. The method of claim 16, further comprising, based on identifying that the requirement of the second data session is more than the remaining capacity of the first network slice, selecting a second network slice from the plurality of network slices.
